(19) United States
(12) Patent Application Publication
(10) Pub. No.: US 2011/0088310 A1
(43) Pub. Date: Apr. 21, 2011

(54) CRAWLING INSECT BAIT STATION WITH INTERNAL BAIT RESERVOIR SEAL AND SIMULTANEOUSLY ADJUSTABLE INSECT ACCESS PORT AND CRAWLSPACE DIMENSIONS

(76) Inventors: Christie Parker, Tempe, AZ (US); Frederique M. de Lame, Scottsdale, AZ (US); Judith A. Wallis, Chandler, AZ (US); Richard Seager, Mystic, CT (US)

(21) Appl. No.: 12/991,150

(22) PCT Filed: May 8, 2008
(86) PCT No.: PCT/US08/05897

§ 371 Date: Dec. 10, 2010

(51) Int. Cl. A01M 1/20

(52) U.S. Cl. 43/131; 43/132.1

(57) ABSTRACT

A fully adjustable, crawling insect bait station is provided that is sealable for use with liquid, gel or solid baits, and wherein movement of a cap relative to a base portion simultaneously dimensions both the insect access port(s) and an internal crawlspace at the top of the inner reservoir wall to a selected size for particular insects. The bait station of the present invention is distinct and significantly improved over prior bait stations in that there is no antechamber between the insect access port(s) and the inner bait reservoir where crawling insects may unproductively congregate. Once insects enter the bait station of the present invention they encounter a sloped access means that leads them directly over the inner reservoir wall to the poisoned bait.

### FIELD OF INVENTION

The invention relates to poison bait holders for the control of insect populations and more specifically to a two-piece bait station that features the simultaneous (a) unsealing of an internal bait reservoir and (b) insect access port(s) and crawlspace size adjustment, from a single movement of the cap relative to the base portion.

### BACKGROUND

Crawling insect bait stations are well described in the literature and found extensively in both professional and consumer markets. Most home improvement centers and hardware stores carry an assortment of stations for controlling crawling insect populations, most particularly ant and roach. These crawling insect stations are often very simple plastic holders made from thermoform plastic, having an internal portion to position a bait, along with various openings (or “access ports”) and inclines for the crawling insects to come and go from. Baits run the gamut of physical form, including liquid, gel, granular and solid. Each of these physical forms of bait comprises some sort of food mixture (e.g. protein, fat and carbohydrate mixture) along with an insecticide. Stations are designed such that crawling insects can feed on the bait, then leave the station and return to the nesting area. Therefore the access port size, number and location, the pathway (or crawlspace) clearances, the length of the pathways, along with the angles of the ramps on which the insects can transverse from the ground to the bait, are each important parameters.

Many simple bait stations use solid baits to eliminate leaking issues, to simplify design and manufacturing, and to substantially reduce cost. For example, a two-piece station constructed of thermoform plastic parts glued or melted together can feature open access ports that cannot be closed. These unsealed stations are merely placed into vapor-impermeable packaging for merchandizing. U.S. Pat. Nos. 4,563,836 to Woodruff, et al., 4,823,506 to Demarest, et al., 4,837,969 to Demarest, et al., 4,841,669 to Demarest, et al., 4,894,947 to Brandli, 5,048,225 to Brandli, 5,802,761 to Demarest, et al., 5,960,585 to Demarest, et al., and 7,043,873 to Westphal, et al. are all examples of these simple “open” bait stations that are suitable for solid baits, but entirely unsuitable for liquid or gel baits.

Liquid bait stations are known, and by necessity must incorporate either some sort of seal for shipping, or be merchandised empty along with a separate filling device (like a syringe full of liquid bait) in a kit for a “refillable” product. One of the improvements seen in liquid bait stations are the “user activated” devices where the end user pushes on part of the station, turns a part of the device, or executes some other motion to a movable part on the device that causes an internal seal to open, pierce or burst, or that causes a wicking process to begin. Once a user-activated device is activated, the liquid bait will flow from one region of the station to another region of the station that is insect accessible, either through gravity or some capillary wicking action into a porous substrate.

Exemplary liquid/gel bait stations include the following: Pending U.S. Application 2005/0252074 to Duston, et al. describes a push-to-activate liquid device wherein a wick is moved into contact with the liquid bait; Now-abandoned U.S. Application 2002/0069579 to Hyatt, et al. describes a liquid bait station that has an antechamber for the crawling insects to enter to find a wetted pad that partitions off, and wicks liquid from, a liquid reservoir; U.S. Pat. No. 7,310,908 to Bernard et al. broadly claims a consumer-activated station where an internal seal is broken on a first reservoir and the liquid bait flows into a second reservoir; U.S. Pat. No. 7,278,235 to Kupfer, et al. claims a liquid bait station where the reservoir is a bottle that is inverted and screwed into the base of the station, and the liquid bait wicks into an accessible area; U.S. Pat. No. 7,204,054 to Mayo, et al. claims a simple station with a reservoir that is pierced by a spike when the reservoir is inserted down onto the base of the unit; U.S. Pat. No. 7,165,353 claims a station with a pad that may be wetted by an aerosolized supply of liquid bait; U.S. Pat. No. 6,871,444 to Bernard et al. claims another embodiment of a consumer-activated device where liquid bait moves from one reservoir to another; U.S. Pat. No. 6,655,079 claims a refillable cylindrical station having a tubular inner structure with spiral passageways; U.S. Pat. No. 6,553,712 to Majerowski claims a liquid station with an internal reservoir that is pierced when pushed down onto an internal spike; U.S. Pat. No. 6,532,696 to Clark, III, et al. claims a liquid bait station that is merchandized as a sealed plastic holder and that requires snipping off of the end with a pair of scissors prior to use; U.S. Pat. No. 6,502,348 to Bernard claims a liquid bait station with exterior ports positioned above the internal reservoir to prevent leaking while in use; U.S. Pat. No. 6,401,384 to Contadini claims a station with a slotted lid for convenient refilling without the need to remove the lid; U.S. Pat. No. 6,195,933 to Woodruff claims a liquid station with capillary feed through tubes to multiple feeding locations; U.S. Pat. No. 6,041,542 to Payton claims a liquid bait station with access ports and passages high above the liquid to prevent spillage and leakage during use; and U.S. Pat. No. 5,943,816 to Hyatt et al. claims a liquid bait station with a turn-to-open cap that raises up to open slits allowing flow by gravity of the liquid bait out of the upper reservoir down to a pad.

In spite of the fact that some of the prior art discloses bait stations with moveable parts, many of these rely on complicated assemblies, e.g. devices with an internal reservoir that can move relative to a base structure down onto an internal spike. Simple devices that have rotating caps include U.S. Pat. No. 6,272,791 to Peasants. The '791 Pleasants patent claims a station with a rotating lid that provides for selection of chambers that may feature separate baits for different pests. The '791 patent is silent as to any particularly improved sealing. The Hyatt et al. device as mentioned ('816 above) features a threaded cap that unscrews and moves upwards to open lower slits and to start dripping of liquid bait down onto a pad. The '816 patent does not clarify how wicking is prevented in storage when these same slits are pressed onto the pad in the closed position, suggesting that in practice there may still be leakage during shipping and merchandizing. Finally, U.S. Pat. No. 5,357,709 to Lin claims a simple station that is opened by rotation of the cap relative to the base. The Lin station ('709) features nested parts with holes and openings that come into registration by rotation of the parts relative to one another, but is also silent as to any improved sealing of these parts.

### SUMMARY OF THE INVENTION

In spite of brisk innovation spanning nearly thirty years, there is still a need for a simple, two-piece bait station that is optimized for liquid and gel baits, but that can still be used for any physical form of bait, and that features the improved sealing needed when transporting and merchandizing the station already filled with bait. Heretofore, there have been no attempts to “double seal” a bait station with both a primary seal at the inner bait reservoir and a secondary seal at the insect access ports.

The present invention provides a simple indoor/outdoor crawling insect bait station suitable to hold any form of bait (liquid, gel, granular or solid), but which is particularly useful for liquid or gel baits because of the secure compression seal at the inner bait reservoir. The bait station of the present invention is completely adjustable, and optionally may be refillable. The salient feature of the device is that one physical adjustment by the user—a single motion of a movable cap—simultaneously unseals an inner bait reservoir (or “bait well”) and opens the lower insect access ports. Also, the degree to which the ports are opened by this motion is mirrored in the distance created between the underside of the cap and the inner bait reservoir (a crawlspace into and out of the reservoir). In this way, the access ports and the crawlspace between the underside of the cap and the bait well are adjusted and dimensioned identically, each simultaneously created by partially opening the cap. In this way the station is entirely adjustable for type and/or size of insect. When the port size and crawlspace dimensions are opened only to the extent necessary based on the size of the insect requiring control, these dimensions are not set larger than required, which is a situation that may create too much airflow and early evaporation of the bait matrix or active ingredient(s). As an option, complete removal of the cap may provide access to the inner bait reservoir for refilling with any form of bait, solid to liquid. Another option is to include a locking feature on the moveable cap to prevent complete removal for safety reasons. Further options may include a rain/weather shroud and/or various spiking means to secure the station to the ground for outdoor use.

That being said, the present invention provides significant improvement over the prior art by, (1) utilizing seals at both the inner bait reservoir (referred herein as the primary seal) and at the outer insect access ports (referred herein as the secondary seal); (2) providing simple and simultaneous opening and sizing of all access ports and crawlspaces by movement of the cap; (3) providing a simple refill option through complete removal of the cap; and (4) incorporating only two parts that fit together through a fastening means, where these two components move relative to one another to distance themselves from each other.

### BRIEF DESCRIPTION OF THE DRAWINGS

FIG. 1 depicts the front upper perspective view of one embodiment of the bait station of the present invention in a fully assembled, closed and merchandisable configuration.

FIG. 2 depicts the exploded upper perspective view of one embodiment of the bait station of the present invention comprising a cap and a base portion, wherein the base portion does not include the optional rain/weather shroud.

FIG. 3 depicts the top view of one embodiment of the base portion of the bait station of the present invention comprising an inner bait reservoir and access means.

FIG. 4 depicts a side view of one embodiment of the base portion of the bait station of the present invention comprising at least one access port and including an optional rain/weather shroud.

FIG. 5 depicts a cross-sectional view of one embodiment of the base portion of the bait station of the present invention comprising upper sealing edge on the inner bait reservoir and access means for scaling the top of the reservoir wall.

FIG. 6 depicts the bottom (underside) view of one embodiment of the cap of the bait station of the present invention comprising a downward projecting reservoir sealing flange and an outer sealing overhang.

FIG. 7 depicts a side view of one embodiment of the cap of the bait station of the present invention comprising a threaded fastening means to movably fasten the cap with the base portion.

FIG. 8 depicts a side view of another embodiment of the cap of the bait station of the present invention comprising at least one flexible tab usable to prevent child tampering, complete removal of the cap from the base portion, or to otherwise limit the extent to which the device may be opened.

FIG. 9 depicts a cross-sectional side view of one embodiment of the cap of the bait station of the present invention comprising a downward projecting reservoir sealing flange further comprising concentric sealing edge and ledge.

FIG. 10 depicts a cross-sectional side view of one embodiment of the assembled and fully closed bait station of the present invention comprising a liquid-tight seal between the downward projecting reservoir sealing flange on the underside of the cap and the upper sealing edge of the inner bait reservoir of the base portion.

FIG. 11a depicts a magnified cross-sectional side view of one embodiment of the liquid tight seal at the inner bait reservoir wherein the downward projecting sealing flange is dimensioned to seal on the inside edge of the wall of the inner bait reservoir.

FIG. 11b depicts a magnified cross-sectional side view of another embodiment of the liquid tight seal at the inner bait reservoir wherein the downward projecting sealing flange is dimensioned to seal directly on the top edge of the wall of the inner bait reservoir.

FIG. 11c depicts a magnified cross-sectional side view of another embodiment of the liquid tight seal at the inner bait reservoir wherein the downward projecting sealing flange is dimensioned to seal on the outside edge of the wall of the inner bait reservoir, against the top of the sloped access means.

FIG. 12 depicts a magnified cross-sectional side view of one embodiment of the seal between the peripheral overhang on the cap and the outer rim of the base portion, and one embodiment of a thread profile form usable to movably fasten the cap to the base portion in the present invention.

FIG. 13 depicts a magnified cross-sectional side view of one embodiment of a sealed insect access port wherein the cap of the device has closed in behind the port opening, and wherein the bottom edge of the cap has sealed onto the sloped access means in the base portion.

FIG. 14 depicts a cross-sectional side view of one embodiment of the fully assembled and partially opened bait station of the present invention, wherein the crawlspace dimensioned at the top of the inner bait reservoir and the extent to which the insect access ports are opened, are necessarily identical.

FIG. 15 depicts an upper perspective view of one embodiment of the bait station of the present invention comprising a separate and optional staking member that may be supplied with the station and engaged through an appropriately sized hole in the optional rain/weather shroud to secure the device to the ground or to a hard surface.

FIG. 16 depicts a perspective view of one embodiment of the bait station of the present invention wherein an optional integral spike may be broken off from the rain/weather shroud and used as a securing means to secure the station to the ground.

### DETAILED DESCRIPTION OF THE INVENTION

The following description is of exemplary embodiments only and is not intended to limit the scope, applicability or configuration of the invention in any way. Rather, the following description provides a convenient illustration for implementing exemplary embodiments of the invention. Various changes to the described embodiments may be made, for example in the look, design, shape and arrangement of the elements described without departing from the scope of the invention as set forth in the appended claims. Additionally, though described herein in general terms of a crawling insect bait station that may be used in conjunction with liquid, gel, granular or solid bait matrices for the control of ants, other designs of the bait station are contemplated. For example, larger structures, which could in principle be used to control cockroach, silverfish, earwig, cricket, or even rodent populations, are anticipated. Although the preferred embodiments are optimized for controlling ant populations, the station of the present invention could easily be enlarged significantly in size, (e.g., even five to ten times as large) in order to accommodate and control rodents. More moderate sized stations could be used for controlling larger insects such as cockroaches and crickets. Additionally, although the preferred embodiments of the insect bait station comprise a cap and base portion each having threaded fastening means to couple these two portions together in a moveable arrangement, other fastening means are anticipated and within the scope of the present invention. For example, a pull-to-open arrangement, e.g. with notched height adjustments to choose the degree to which the device is opened, or even simply a tight-fit (a “friction fit”) between the components, are anticipated variations to a threaded arrangement between the cap and base portion. Also, the preferred design for the device is round (i.e., disc/hockey puck shaped), due to a preference to incorporate a threaded arrangement between the cap and base portion. However many other shapes such as square or rectangular may be used if the cap and base portion are movably engaged by fastening means other than screw threads. Lastly, many decorative and functional elements are variable and obvious to incorporate. For example, many gripping means can be envisioned for the movable cap, (e.g. protruding ribs or a knob or handle, or recessed finger holes or “scallops”, and the like) such that a consumer can grip the cap and move it relative to the base portion.

The present invention may be crafted out of a number of materials and may comprise different materials between the components. Although plastic is the preferred material of construction, less suitable materials such as metal, glass and ceramics are anticipated. The preferred process to manufacture the components of the present invention is thermoforming, injection molding or injection blow molding of plastics such as polyethylene (PE), polypropylene (PP), polyethylene terephthalate (PET), polyvinyl chloride (PVC), polystyrene (PS), nylon, polycarbonate, and the like, and combinations thereof. It may be useful to use different hardness of plastic for various components such that one component can deform against another in sealing arrangement. It may also be useful to fluorinate the plastic, or treat it in other ways either during or after molding to make it more chemical resistant. Various surfaces, particularly those that insects are expected to walk/climb on, may be textured, for example in the molding process, or in a subsequent operation. It may be desirable to use various colors of plastic, for example for aesthetics, for blending into a particular landscape, or for controlling the internal temperature of the station through reflection/absorption of UV radiation. To this latter idea, various UV absorbers, pigments or finishes may be used to adjust the affect of sunlight on the device. Lastly, it is anticipated that the surfaces both inside and outside the bait station may have various texturing, ribbing, roughness and the like for functional reasons (e.g., to affect the way insects interact with the station, or the way the station repels the elements) or for aesthetics, brand recognition and the like.

It is especially important to realize that although the bait station of the present invention is described as preferably comprising a cap and base portion (i.e., two components), the cap and/or the base portion of the present invention may comprise assemblages of more than one component each. For example, a rain/weather shroud may be a separately manufactured sub-component that is snapped onto the bait station of the present invention rather than integrally molded as part of the base portion or the cap. Alternatively, the cap and the base portion of the bait station of the present invention may be integrally connected (e.g., tethered), having been molded as one piece with a “living hinge” (particularly appropriate for a bait station of the present invention that does not include screw threads), or where the cap and base portion are tethered with a third component.

That being said, the crawling insect bait station of the present invention minimally comprises a base portion and a cap movably fastened to the base portion such that movement creates distance between the parts; the base portion including: (a) an outer wall with at least one insect access port at the bottom of the base portion, and fastening means for securing a movable cap, (b) an internal bait reservoir defined by an inner reservoir wall offset horizontally from said outer wall, and (c) means on the exterior of said reservoir wall, and optional means on the inside of said reservoir, for facilitating climb/descent of said inner reservoir wall; The movable cap including: (a) an outer wall with fastening means for moveable attachment to said base portion, and (b) a downwardly projecting inner reservoir sealing flange offset horizontally from said cap outer wall, dimensioned and aligned to sealingly mate with top sealing edge of said inner reservoir wall when the movable cap is fully secured to the base portion.

Accordingly, a bait station of the present invention opens by movement of the movable cap, preferably through a “turn-to-open” configuration, (e.g. by way of complementary threads as the fastening means on cap and base portion), or through a “pull-to-open” configuration (e.g. by way of complementary guidance slots and ribs on cap and base portion). By design, distancing the cap from the base portion opens the insect access port(s) to the same dimension (height) that the downwardly projecting inner reservoir sealing flange on the underside of the cap distances from the top edge of the inner reservoir wall. In this way, the height of all insect access port(s) and crawlspaces together are identically adjusted and set. These unique features, along with preferred embodiments and optional designs, are described below with reference to the drawing figures.

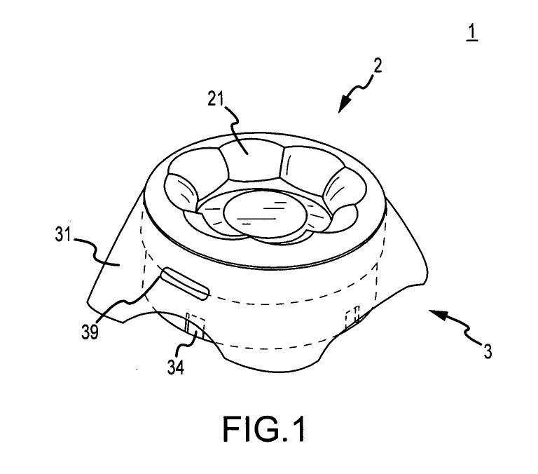

Referring now to the drawings in detail, a crawling insect bait station of the present invention is shown and generally designated as reference numeral 1. It should be noted that for clarity, some features of the bait station might not be shown or pointed out in each of the various drawings. Lastly, spatial directions such as “top” or “bottom” or “up” or “down” or “underside” are used throughout, and relate to the orientation of the bait station as it is shown in FIGS. 1, 15, and 16. However, depending on the physical form of the bait used within the bait station, the insect bait station may be deployed in a variety of orientations. For example, if solid bait is used, the station may be fastened to a vertical surface or leaned up against a sloped or vertical wall since there would be no leakage issues. Perhaps with low-viscosity liquid baits, the ability to tilt the station while in use may be more limited, and the orientation in use may need to be more like the orientation shown in FIGS. 1, 15 and 16.

That being said, FIG. 1 depicts one embodiment of the bait station of the present invention 1 in the closed position for shipping, storage and merchandising. As shown in FIG. 1, bait station 1 is comprised of movable cap 2 and base portion 3. In this configuration as depicted, cap 2 is fully closed/mated onto base portion 3. Optional gripping means, for example in this embodiment, finger recesses or “scallops” 21, allow the consumer a means to grip the cap 2 to move it and distance it relative to the base portion 3. As mentioned previously, many gripping means may be envisioned and incorporated on cap 2. Non-limiting examples include a recessed or protruding handle (e.g., like a gas-filling cap on a car), or a slot or other recessed geometric shape that accepts a special tool of complementary shape to prevent anyone (e.g., children) without possession of the tool from opening the device, or a raised/ribbed “knob” (e.g., resembling an old style radio knob), and the like. These examples are to illustrate that many imaginative gripping means can be envisioned for the cap 2 such that suitable functionality is included to aid opening/closing, or to prevent unauthorized access. Certainly, gripping means may also, or alternatively be incorporated on the base portion 3 to aid opening/closing. Also, the gripping means of choice may relate to how the cap 2 is designed to move relative to the base portion 3, (e.g., a twist-to-open versus a pull-to-open configuration). The gripping means may also comprise design elements such as an embossed, raised or recessed brand name, logo or such, to not only help identify the product but also to provide means for holding onto and moving the cap. For example, the gripping means on cap 2 may simply be the raised block letters spelling out the brand name COMBAT®, effectively bisecting the cap with a raised handle for gripping. If the block letters are recessed within the cap, they may provide finger recesses to aid moving the cap.

Referring still to FIG. 1, the base portion 3 is shown with optional rain/weather shroud 31. This shroud may take on any one of a variety shapes and sizes. For example, the lowest edge may be contoured such that the should doesn't block off a particular pathway to an insect access port, or such that it shields particular ports from the elements. Or the shroud 31 may be eliminated entirely if the bait station is marketed only for indoor use. A variety of shapes, slopes, features, and decoration are possible for this shroud because unlike many bait stations, this shroud is not an insect pathway ramp. As described more thoroughly below, the shroud 31 may further comprise an integral staking means that may be broken off and used for securing the device to the ground in outdoor applications. A preferred embodiment for the shroud is simply a skirt that encircles the station and that is sloped downward away from the cap of the device such that rain slides off away from the station, giving the insect access ports protection with a sort of “awning”. A preferred shroud is shown in FIG. 1 comprising “waves” around the lowest (bottom) edge against the ground so that pathways to the station ports remain accessible. This preferred shroud is also shown with at least one hole 39 somewhere through it to accept an optional stake, nail, screw, or other suitable fastening member, in order to affix the station to the ground or to some other surface. A separate stake may be included along with the bait station in a pouch or carton. Lastly, FIG. 1 shows at least one insect access port 34 configured at the bottom of the base portion 3 such that the port(s) will be at ground level in use. This port 34 is shown closed off and sealed from behind by a portion of the cap 2 when the bait station is in the closed position as shown in this figure (discussed below).

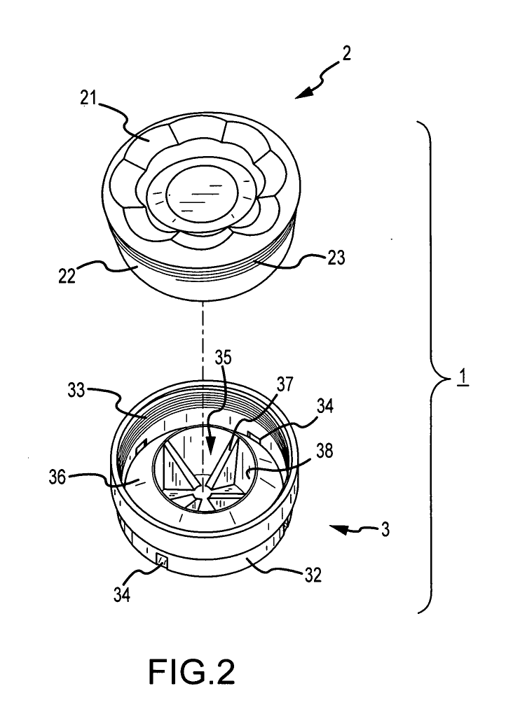

As shown in exploded view in FIG. 2, the bait station 1 of the present invention is comprised of cap 2 and base portion 3 that may be movably attached to one another through suitable fastening means configured on at least one, and preferably both, of these two components. Such fastening means must allow for ease in distancing the cap from the base portion by some sort of convenient motion. For example, both outer wall 22 of cap 2 and outer wall 32 of base portion 3 may include complementary screw threads 23 and 33, respectively, as the fastening means for suitably mating cap 2 and base portion 3 in movable arrangement. Consequently, a threaded arrangement allows the consumer to distance the cap from the base portion by rotating one part relative to the other. Shown in FIG. 2 is one thread profile form suitable for use in the present station, comprising a single continuous thread turn with about 14 TPI (threads per inch). Useful thread profile forms may comprise any pitch, depth and TPI, and may conform to any of the familiar thread standards (ISO Metric, SAE Unified, BA, and BSW) out of convenience, or a custom thread profile form not previously standardized. Additionally, suitable threads may comprise more than one separate thread turn that provide more than one “thread start” on which to engage the cap to the base. This may be practical for a refillable station where the consumer is expected to remove the cap completely for refilling. The multiple thread starts would simplify engaging the cap back onto the base portion. The TPI is somewhat unimportant, although the finer the threads, (greater TPI), the more precise the possible adjustment of the device. As will be described below, finer threads allow the user to unscrew and distance the cap away from the base in a very precise and controlled manner, opening up the insect access ports and crawlspaces slowly. However, when threads are incorporated on these pieces as the fastening means, even one thread turn, that is 1-thread per inch, on the cap and on the base will suffice, allowing the consumer to open the device with a short single twist of the cap relative to the base (for example, a 90° rotation) rather than having to turn the cap around and around to affect any change. The preferred TPI in a threaded arrangement for the cap and base portion is between about 1 TPI and 16 TPI. Coarser thread configuration is more preferred than finer thread configuration so that less motion and effort is required by the consumer to open and close the device.

In a preferred embodiment shown in FIG. 2, threads 23 are incorporated on the outside of outer cap wall 22, and threads 33, complementary to cap threads 23, are incorporated on the inside of the outer wall 32 of the base portion 3. Even though this configuration is preferred, it is important to realize that the cap 2 can fit inside rather than outside the base portion 3. FIG. 2 shows an embodiment where the cap 2 fits inside, rather than outside, base portion 3. This is the preferred configuration, although an outside fitting cap would easily work in models without a rain/weather shroud (e.g., in the embodiment in FIG. 2 devoid of the optional shroud), or in designs where the outside fitting cap incorporates a rain/weather shroud as a circumferential skirt around the cap. For an outside cap version, the threads 23 would be configured on the inside of the outer wall 22 of the cap, and likewise the threads 33 on the base portion 3 would be placed on the outside of the outer wall 32. As mentioned, the embodiment in FIG. 2 is shown without the optional rain/weather shroud, and such a configuration is entirely acceptable, less expensive to make, and very suitable for indoor use.

In addition to optional gripping means and/or brand names, logo and such that may offer product recognition and a gripping means in one, cap 2 and base portion 3 may also include indicia to show the consumer how much to open the cap for a particular use. For example, marks may be placed on cap 2 and base portion 3, along with wording such as “ANT”, or “SMALL ROACH”, or “LARGE ROACH”, to show the consumer how far to turn and thus distance the cap 2 from the base portion 3 for a particular size of insect. The consumer would be instructed to open the station to align particular marks for a certain type of insect. Ideally a chart would be included that has pictures/icons of the various insects down one column (e.g., various ant species) each corresponding to a number placed in the adjacent column, each number corresponding to a mark on the station to which the consumer is to open the station to control the particular insect chosen. This embodiment is especially practical where a threaded arrangement is used to movably fasten the cap and base portion, and wherein those threads are comprised of only about 1-thread per inch. Thus configured, the consumer may twist the cap 2 relative to the base portion 3 to various positions that together comprise about one full rotation of the cap. For example, to open the device for “ANT” the consumer may need only a 30° twist opening of the cap. “SMALL ROACH” may require another 30° opening (for a total of)60°, and the “LARGE ROACH” setting may require a full 90° turn of the cap relative to the base portion. For each of these sequential positions, the internal crawlspaces along with the opening(s) of the insect access port(s) will be set to increasingly larger dimensions, up to the fully opened setting. These markings accentuate the fully adjustable capability of the device of the present invention. Additionally, detents may be molded into the cap and base portions such that each of these prescribed settings may be “felt” as positive stops when turning the cap relative to the base portion through each of the prescribed degrees of opening.

Alternative but less preferred fastening means may be incorporated on the cap 2 and the base portion 3 for movably connecting the two together (alternatives are not depicted). Various means such as slots and complementary ribs, bumps or other suitable protrusions that are juxtaposed and aligned to register, may provide controlled and guided travel of the two parts relative to one another. For example, circumferential ribs and slots (i.e., horizontally arranged) may be used to provide stopping points for a simple “pull-to-open” arrangement where the fastening means between the parts is simply a friction fit (i.e., a “tight” fit). In any configuration other than threaded, the cap and base portion may be any shape other than cylindrical. For example, nested square or nested rectangular cap and base portions may be incorporated for an overall square or rectangular shaped station respectively. Combinations of shapes are anticipated such as where the overall shape of the device is square yet the inner reservoir shape is cylindrical, and vice versa. All geometrical shapes are anticipated even though the most preferred configuration for the overall device and the inner bait reservoir is cylindrical, and the preferred fastening means for the cap and base portion are standard screw threads. It is important to note that the fastening means may be as simple as a friction fit between the two parts, (that is, the embodiment depicted in FIG. 2 with the threads removed from both components). However, with that arrangement, it would be preferred to incorporate at least one “stop” (with a suitably configured detent and complementary slot) such that the consumer can't easily pull the cap 2 completely out of the base portion 3 while straining against the tight fit between the cap and base portion.

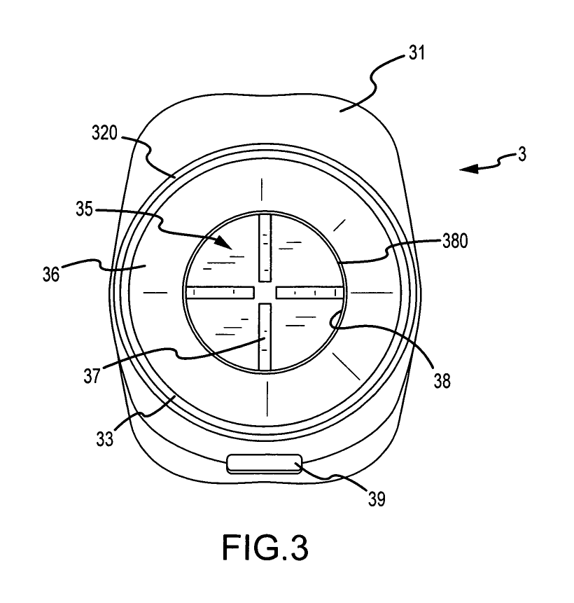

Referring now to FIG. 3, the base portion 3 of the bait station of the present invention comprises an inner bait reservoir 35 further comprising an upper sealing edge 380 on reservoir wall 38, along with means 36 and optional means 37 on each side of the wall 38 to assist a two-way climb and descent of this wall by the insects. Reservoir wall 38 is offset horizontally from the outside of the station, and in the preferred embodiment, the wall 38 is concentric with the preferably cylindrical outer wall of the station (element 32 in FIG. 2). As will be described later, the preferred shape for the interior of the inner bait reservoir 35 is cylindrical, and thus in that embodiment the wall 38 forms the cylindrical boundary to the reservoir. The wall 38 is preferably substantially vertical on its inner side (i.e., the side facing the bait) to maximize the volume of the bait reservoir. Depending on the height of this substantially vertical wall, separate means 36 along with optional means 37 may be required to allow insects means to breach this vertical wall and visit the bait. As shown in a preferred configuration in FIG. 3, such optional means on the inside of the reservoir may comprise a series of angled ramps 37, and here the means are depicted as comprising four (4) wedge-shaped, small angled ramps 37. The preferred configuration may incorporate between 1 and about 8 angled ramps leading from the top edge 380 of the reservoir wall 38 down into the bait reservoir 35, with between 2 and 6 wedge-shaped ramps most preferred. The preferred angle of these access ramps 37 is from about 30° to about 60° degrees from horizontal, with about 50° most preferred. Even more preferred is to configure the means 37 as four (4) separate wedge-shaped angled ramps of from about 1 mm to about 5 mm in width, angled at about 50° from horizontal from the top edge 380 of the wall 38 down to the floor of the inner bait reservoir 35. The ramps may be textured to give the insects an easier grip to the ramps. For example, the ramps may be lightly terraced or bumped or roughened. It must be stressed that more ramps are anticipated, and in the extreme, (i.e., “infinite” number of ramps 37), the inner reservoir becomes bowl shaped, with the means 37 comprising a circumferential skirt sloping down from the upper edge 380 of reservoir wall 38 into the reservoir. This configuration is not preferred simply because the volume of the reservoir would be seriously compromised, (unless the bait station is dimensionally enlarged in size, abnormally so for crawling insects). However, if there are extremely concentrated baits, for example if bait matrices are available or become available in the future that can be deployed in very small amounts, this skirt configuration for means 37 may be practical.

That having been said, the preferred volume for the inner reservoir 35 is from about 3 mL to about 30 mL, with about 10-20 mL most preferred for liquid baits and around 3-8 mL most preferred for gel baits. In this way, the preferred interior shape of the inner reservoir is cylindrical, with several access ramps employed as means 37 described above. In the most preferred configuration (as depicted in FIG. 3), a cylindrical reservoir having diameter of around 4 cm, (and depth of about 1 cm, not visible from this top view), the preferred volume of about 10-20 mL is achieved since these several ramps 37 of about 2 mm width inside the cylindrical reservoir 35, do not take up much volume. As shown in FIG. 3, wedge-shaped access ramp create “partitions” within the reservoir 35, and when employing solid baits, they may be positioned in these spaces. Different solid bait materials can be distributed in these various regions created by the ramps. When incorporating liquid or gel baits, these materials will simply flow between each of the ramps 37 and fill the void spaces within reservoir 35.

It is important to note that means 37 is optional, and may be eliminated entirely. That is, the preferred wedge-shaped ramps can be removed altogether, provided that the reservoir wall 38 is no taller than about 4 mm when the bait station is used to control ants. For controlling larger insects, this wall 38 may be higher yet still not require means 37 on the inside of the wall 38 to facilitate breach. Entirely eliminating means 37 on the inside of the reservoir makes it easier to insert solid bait into the bait well and may become important to speed up manufacturing or to make refilling easier for the consumer. Thus, one very workable embodiment of the present invention for smaller insects such as ants comprises a base portion 3 with reservoir 35 comprising wall 38 and only sloped means 36 on the outside of wall 38, and no sloped access means connected to the inside of wall 38.

Still referring to FIG. 3, the means employed for the insects to breach the inner reservoir wall 38 from outside of the wall is somewhat different than what was preferred for the inside of the wall. As shown in FIG. 3, means 36 for the insects to travel from the station access ports to the top sealing edge 380 of the inner reservoir wall 38 and back is preferably an entire sloped surface that circumscribes the inner bait reservoir as a skirt. Unlike many prior crawling insect bait stations, we have found that an inner horizontal floor between an inner bait reservoir and the outer wall of the bait station is completely unnecessary. Indeed, it is preferable to slope the access means 36 directly from the insect access ports up to the top edge 380 of the reservoir wall 38 without incorporating any intermediate horizontal surface for the insects to congregate on. That is, when the insects enter the station from the outside environment, they only encounter the sloped surface (means 36) and they must begin their ascent immediately to the reservoir upon entering the station, or they exit out. Not only is this convenient for the overall design/molding of the station, but it is preferred not to have a horizontal floor around the inner bait reservoir (a so-called “antechamber”) that merely increases time/distance required for the insects to find the bait. Thus, to avoid creating an undesired antechamber, means 36 is preferably configured to traverse the entire distance between the outer insect access ports and the inner wall 38, and is preferably a continuous circumferential skirt rather than separate ramps as preferred for inside the bait well. The preferred angle for means 36 is the same as for means 37, and is from about 30° to about 60° degrees from horizontal, with about 50° being the most preferred angle. As with optional means 37 discussed above, means 36 may also be lightly terraced or bumped or roughened in ways that facilitate climbing of the surface by insects.

Also visible in FIG. 3 is the top of the threads 33 that are preferably configured on the inside of the outer wall of the base portion 3 and an upper sealing ledge 320 that is configured to mate with an overhang configured on the cap (discussed below). Lastly, this view of a preferred base portion 3 in FIG. 3 also shows an optional rain/weather shroud 31 and an optional hole 39 in the shroud that can be configured to accept a spike, nail, screw or other fastener designed to secure the station at a chosen location.

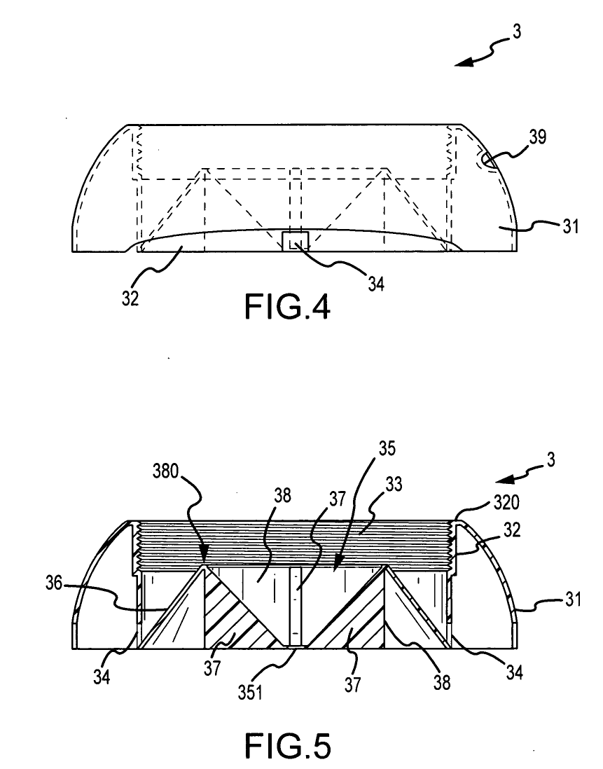

Referring now to FIG. 4, the insect access port(s) 34 of the bait station comprise closable passageways through the outer wall 32 of the base portion 3, and these may be configured in any of several practical geometrical shapes (round, square, rectangular, triangular, and the like). The preferred shape for the insect access ports is square or rectangular, with the preferred size being from about 1 mm to about 1 cm in height, width or both. For example, a preferred bait station may comprise four (4) access ports 34, each measuring about 3 mm to 6 mm square, symmetrically arranged at the (4) compass points around the bait station, and at the lowest point of the wall 32 (so that the ports are at ground level). At least one access port 34 is required for the present invention, however having several are preferred. The most preferred bait station comprises between about four (4) and about eight (8) small, square or rectangular insect access ports distributed symmetrically around the base portion of the station. Insect access ports 34 provide entry into the bait station for crawling insects entering from the outside environment (either indoor or outdoor space outside the station) onto the sloped means 36 whereon they begin their ascent to the bait well containing poisoned bait, (seen best in FIG. 2). As will be described below, the outer wall 22 of the cap, (see cap 2 in FIG. 2), functions as the “shade” that opens from either behind or in front of the insect access ports 34 as the cap 2 is distanced from the base portion 3. FIG. 4 also shows an optional rain/weather shroud 31 and an optional hole 39 in the shroud, which may be configured to accept a spike, nail, screw or other fastener designed to secure the station at a chosen location.

FIG. 5 depicts a cross-sectional view of one embodiment of the base portion 3 of the bait station of the present invention. Present in this view are the preferred bait reservoir access means 36 and 37 in cross-section, designed such that insects may ascend and descend the upper edge 380 of the reservoir wall 38. Means 36, preferably configured as a circumferential skirt that traverses the space between the outer wall 32 of the base portion and the inner reservoir wall 38, along with optional means 37 preferably configured as between one (1) and eight (8) wedge-shaped angled ramps sloping from the top edge 380 of the reservoir wall 38 down to the reservoir floor 351, are readily visible in this view (showing two of the ramps 37 in cross-section, and one edge-on, of the four total that are preferred). The floor 351 and wall 38 of the bait reservoir 35 preferably form a cylindrically shaped reservoir 35. Cross-sections of two insect access ports 34 are also shown in this view, emphasizing that insects entering the ports 34 will immediately encounter the sloped access means 36 rather than any extended horizontal floor of an antechamber. Lastly, base portion outer wall 32 and fastening means 33 are depicted. In this preferred configuration for the base portion 3, preferred means 33 is shown as one thread profile form cut on the inside of the outer wall 32 although as mentioned above, coarser threads are even more preferred. As evident in FIG. 5, the outer wall 32 need not be molded as a smooth continuous vertical surface on the outside. Indeed, in this particular embodiment drawn, the outer wall 32 appears thicker and offset to a wider diameter at its uppermost portion in order to accommodate the depth of the screw threads 33. However, there is no reason why the outer wall 32 could not be contiguous on its outer surface even though not contiguous on the inner surface because of the screw threads cut into it. When different fastening means 33 are incorporated, the thickness of this wall 32 can be altered accordingly. For example, in the complete absence of screw threads, where the two components of the bait station simply press-fit together and the fastening means is the “tight-fit”, the wall 32 may be quite thin. If deep threads are to be used as the fastening means 33, the wall 32 may be thicker.

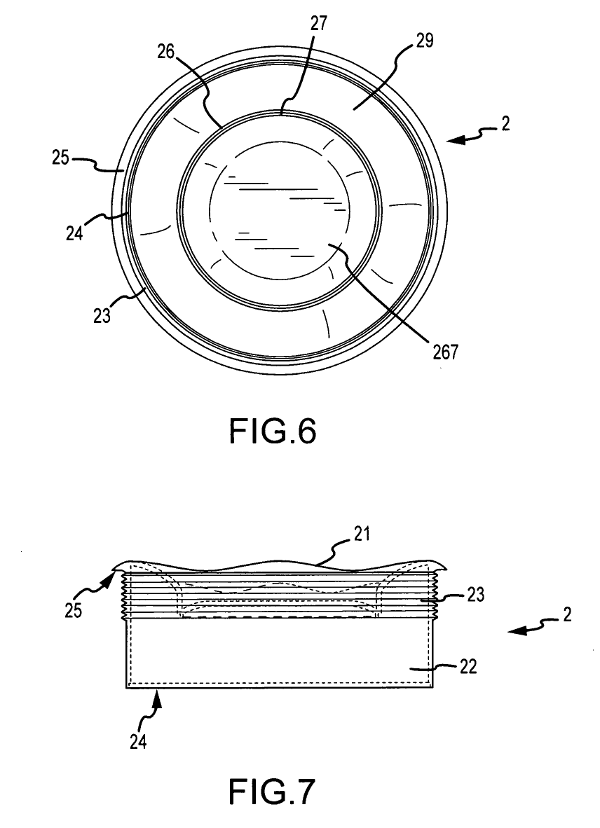

FIG. 6 depicts the bottom (i.e., underside) view of one embodiment of the cap 2 of the bait station of the present invention. In addition to an overhang 25, the underside of the cap 2 preferably includes a downwardly projecting reservoir sealing flange further comprising a sealing edge 27 and lip 26. In the preferred embodiment wherein the inner bait reservoir is cylindrical in overall shape, this downwardly projecting reservoir sealing flange is preferably circular, and thus edge 27 and lip 26 are concentric as illustrated. In the most preferred configuration, the downwardly projecting reservoir sealing flange is a “cap within a cap”. That is to say, the sealing flange is preferentially another cap molded into the underside of the bait station cap by way of cap portion 29. This sealing flange is preferably concave and disc shaped, like a circular cap that fits on the inner reservoir, although other geometrical shapes are anticipated so long as the sealing flange shape is complementary to the reservoir shape in order to seal it. For example, this downwardly projecting flange may be square shaped to fit a substantially square shaped bait reservoir. The depth to which this flange projects downward will be discussed below with the aid of FIGS. 7, 9, 10 and 14. But what is important is that this flange is configured to close down upon the upper edge of the wall of the inner bait reservoir when the cap 2 is fully engaged upon the base portion. In this manner, the primary sealing point in the bait station of the present invention is formed, wherein the downwardly projecting reservoir sealing flange acts as a cap for the inner reservoir when the overall cap 2 is secured down onto the base portion of the device. This inner cap is bounded essentially by the combination of wall 29, top 267, edge 27 and lip 26. As mentioned above, the bait station of the present invention is especially useful for liquid or gel baits. As such, a liquid-tight seal directly around the top of the reservoir is essential and certainly a practical way to contain the bait within the small volume of the reservoir, rather than relying on liquid seal points elsewhere on the device. Various sealing mechanisms may be envisioned between the downwardly projecting reservoir sealing flange shown in FIG. 6 and the upper edge of the reservoir (element 380 in FIGS. 3 and 5). As discussed below, in the preferred embodiment, this seal is a compression fit relying on the flex and deformity inherent in plastic components, particularly when components are of differing hardness of plastic.

Referring now to FIG. 7, a side view of one preferred embodiment of the cap 2 of the bait station of the present invention is shown. Cap 2 comprises a threaded fastening means 23 configured on the outer wall 22 such that the cap may movably engage with the base portion. As discussed thoroughly above, the fastening means 23 need not be screw threads at all, and if threads are even incorporated, they may comprise a variety of thread profile forms. Recall that one anticipated embodiment is the complete elimination of threads 23, wherein cap 2 would simply press fit into the base portion and the fastening means 23 would be simply the friction fit between two tight fitting components. FIG. 7 also shows that the cap is preferably configured with an overhang 25 that is configured to seal upon the top edge of the base portion when the cap is fully engaged and closed down upon the base portion. Although not a primary seal, this seal forms one of three seal points in the present invention.

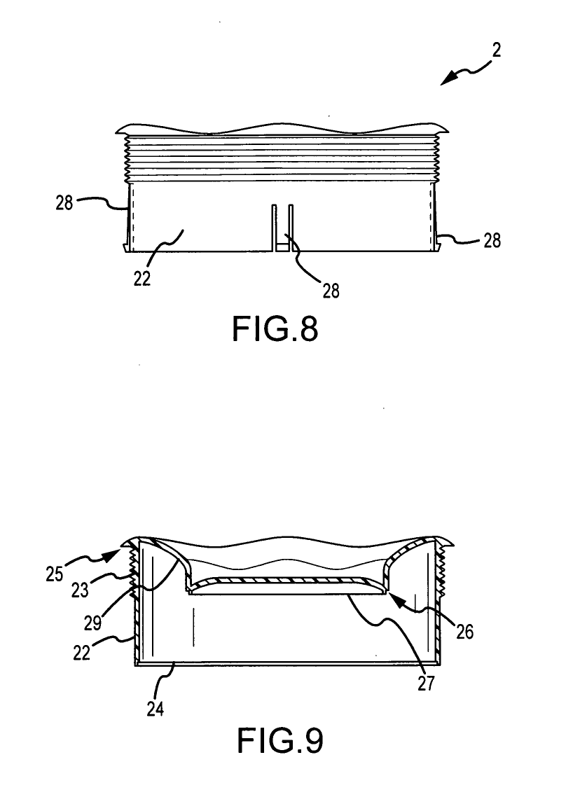

FIG. 8 depicts a side view of another embodiment of the cap 2 of the bait station of the present invention comprising at least one flexible tab 28 that may be used to prevent complete removal of the cap from the base portion, and/or to impart child-resistance or other functional features to the invention. For example, tab 28 may protrude through one of the insect access ports 34, or through a separate hole appropriately positioned on the base portion, preventing movement of the cap relative to the base portion unless the consumer pushes the tab in while simultaneously moving the cap. Alternatively, tab 28 may be positioned adjacent to an insect access port (or between any two of them) when the bait station is in its closed position. Then when the user rotates the cap relative to the base portion to open the station, the tab may spring and lock into the first available opening encountered, thus preventing any further turning or opening. In another embodiment, one or more tabs 28 may be positioned in one or more vertical tracks cut into the inside of the base portion such that the tab(s) 28 register and ride in these tracks as a guidance means for use in a “pull-to-open” bait station. Holes may be provided in these tracks wherein the at least one tab 28 can snap into when the consumer pulls the cap out to a predetermined distance from the base portion. These non-limited examples are to show in a general way that at least one flexible tab 28 positioned on wall 22 of the cap 2 may allow for unique safety and functional features for the present invention. The tab 28 preferably flexes in relation to the wall 22 of the cap 2 through a “living hinge”. That is, the tab 28 may be molded into the lowest portion of the cap 2 by leaving only the top edge contiguously connected with the cap wall and this connection being the flexing point. The tab 28 is preferably molded with a small protruding portion that can snap into various positions around the base portion as mentioned.

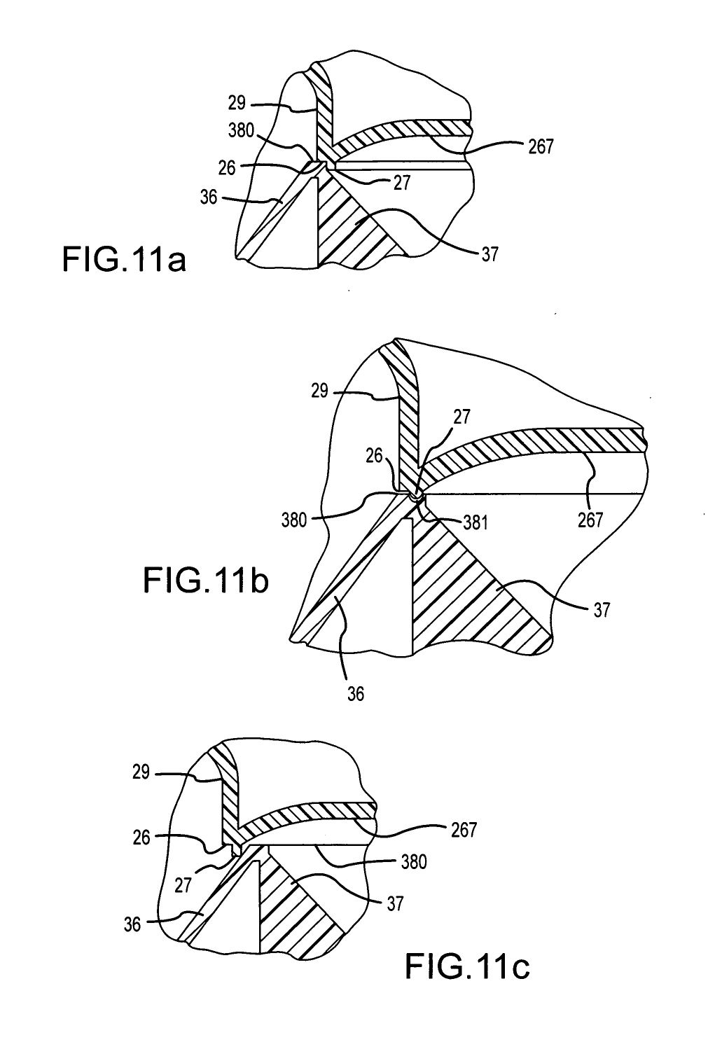

Referring now to a cross sectional view of a preferred cap 2 in FIG. 9, a downward sloping interconnecting wall 29 may be incorporated to merge together the downwardly projecting reservoir sealing flange to the underside of the overall cap 2. As mentioned above, the sealing flange is essentially a smaller second cap molded on the underside of the larger overall cap 2. Downward projecting sealing flange may be comprised of a concentric sealing edge 27 and corresponding lip 26 that merge contiguously by connecting wall 29 to the outer wall 22 of the cap. For use with the preferred cylindrical shaped reservoir, the sealing flange is necessarily circular in order to be complementary in shape. However, (and as will be discussed in the aid of FIGS. 11a-c), the diameter of the sealing edge 27 may be slightly larger, slightly smaller, or precisely the same diameter as the diameter of the inner bait reservoir. In this way, the sealing edge 27 may seal (a) on the inside of the reservoir wall 38, (b) directly down onto the upper edge 380 of the wall 38 (if the diameters are matched), or (c) on the outside of the reservoir 38 (friction fitting against the uppermost edge of sloped access means 36). The seal between the downward projecting sealing flange and the reservoir is the “primary seal” in the present invention—a positive and liquid-tight seal at the reservoir. Depending on the precise finish of the access means 36 and 37 with the top edge 380 of the reservoir wall 38, it may be preferred to configure the sealing edge 27 to either fit inside or outside the reservoir edge 380 as will be discussed below. In a preferred configuration, edge 380 may comprise a recessed slot to accept the sealing edge 27 directly into it. The depth to which the downward projecting sealing flange extends into the base portion when the cap is on the base portion of the station necessarily depends on the height of the inner bait reservoir in the base portion. The slope of 29 is adjusted to provide sealing surfaces 26 and 27 at the correct depth within cap 2 to meet and seal onto the reservoir when the cap is fully seated and closed onto the base portion.

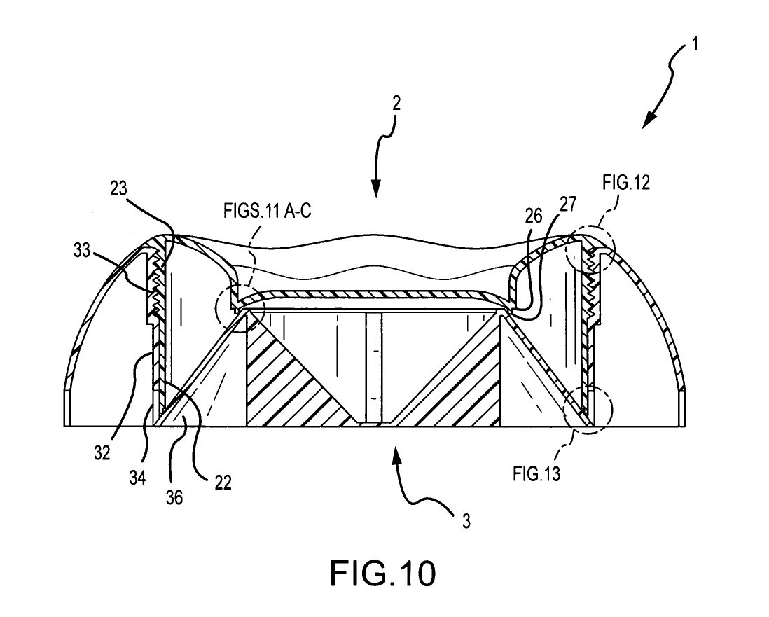

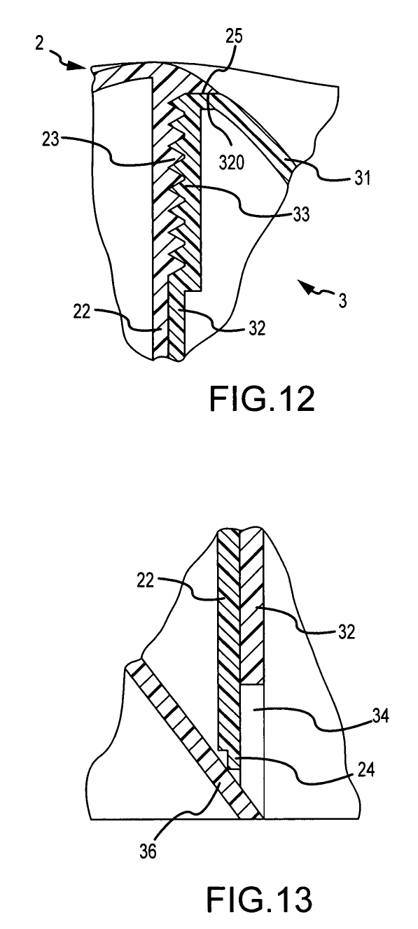

FIG. 10 depicts a cross-sectional view of one embodiment of the assembled and fully closed bait station 1 of the present invention in order to highlight the three sealing points in the assembly when the cap 2 is fully seated into the base portion 3. As mentioned, one important and distinguishing feature of the present invention is that it preferably has multiple sealing points. Most preferred is that a primary liquid-tight seal is configured right at the top of the inner bait reservoir, and that this primary liquid seal is backed up by two additional sealing points elsewhere in the device. As FIG. 10 shows, this primary liquid-tight seal region is further detailed in FIGS. 11a-c for three preferred embodiments. A second seal is preferably configured between the overhang of the cap and the base portion of the bait station, and that additional seal point is expanded for view and discussion in FIG. 12. Lastly, a third seal is preferably configured at the insect access ports wherein in the wall 32 of the cap 2 is positioned to seal off these insect openings 34 .when the assembly is closed. As indicated, FIG. 13 will expand and more fully depict this seal area for discussion below. Various elements shown in FIG. 10 include the outer wall 32 of the base portion 3; a cross section of at least one insect access port 34; the wall 22 of the cap 2 forced in behind the insect access port 34 to close it off like a window shade; downward projecting sealing flange further comprising concentric sealing edge 27 and lip 26 shown crushed down and sealed upon the uppermost portion of sloped access means 36; and, complementary threads 23 (configured on outside of cap wall 22) and threads 33 (configured on the inside of base portion wall 32) meshed together to illustrated one possible configuration for the movable fastening between the cap 2 and the base portion 3. As discussed above, relatively coarse and complementary screw threads 23 and 33 are one preferred configuration for the fastening means between the cap 2 and the base portion 3 such that these two components may be easily moved and displaced relative to one another.

FIG. 11a depicts a cross-sectional view of one embodiment of the primary seal between the downward projecting sealing flange configured on the underside of the cap 2 and the inner reservoir 35 of the base portion 3. FIG. 11a depicts a preferred configuration wherein the diameter of the circular sealing edge 27 is slightly smaller than the diameter of the inner bait reservoir such that the edge 27 slips inside of the upper edge 380 of the wall 38 of the reservoir, and lip 26 seals directly down upon the edge 380. This configuration is particularly useful when optional access means 37 are not incorporated and the inside of the reservoir wall is uninterrupted, smooth and cylindrical. As shown, surface 267 (on the underside of cap 2) is the cover for the reservoir, and cap portion 29 couples the components that comprise the sealing flange back to the underside of cap 2.

FIG. 11b depicts a cross-sectional view of another embodiment of the primary seal between the downward projecting sealing flange configured on the underside of the cap 2 and the inner reservoir 35 of the base portion 3. FIG. 11b depicts another preferred configuration where the diameter of the circular sealing edge 27 very closely matches the diameter of the inner bait reservoir 35. Still more preferred is to include a slot 381 cut into the upper edge 380 of the wall of the reservoir, around its circumference. In this way, the sealing edge 27 of the downward projecting sealing flange may sit directly into the slot 381 when the cap 2 is closed down upon the base portion. Furthermore, circumferential lip 26 may be configured to sit and seal upon the remaining substantially horizontal portion of the upper edge 380 of the wall of the reservoir. Thus, FIG llb depicts a preferred configuration where a sealing slot 381 is cut into the uppermost edge 380 of the reservoir wall in order to accept the circular sealing edge 27 projecting from the underside of the cap 2. In this way, when the cap 2 is secured tightly down upon the base portion, a liquid-tight seal is produced such that liquid bait cannot leak from the reservoir. As mentioned previously, with this and other embodiments such as shown in FIGS. 11a and 11c, plastics of different hardness may be used to improve this liquid-tight seal. For example, a softer plastic may be used for the cap 2 and a harder plastic for the base portion 3 or vice versa Additionally, the slot 381 may be dimensioned slightly too small to accommodate the sealing edge 27. In this way, the softer and larger sealing edge 27 may be forced and deformed into the slot 381, giving rise to a really positive liquid-tight seal when the cap is fully engaged down onto the base portion. In a somewhat extreme yet anticipated embodiment, a rubber or synthetic polymer “O-ring” may be inserted into the slot 381 to accentuate the seal between slot 381 and sealing edge 27.

FIG. 11c depicts a cross-sectional view of yet another embodiment of the primary seal between the downward projecting sealing flange configured on the underside of the cap 2 and the inner reservoir 35 of the base portion 3. FIG. 11c depicts another useful configuration wherein the diameter of the circular sealing edge 27 is slightly larger than the diameter of the inner bait reservoir 35 such that the edge 27 fits outside of the upper edge 380 of the wall of the reservoir, and both the edge 27 and the lip 26 flex, crush and seal directly down upon the upper portion of the sloped access means 36, near to where this access means 36 meets the upper edge 380 of the wall of the reservoir. Again, it may be useful to mismatch the hardness of the plastic between the cap 2 and the base portion 3 such that one part may deform against the other to make a tighter seal. In particular, a softer plastic used for the cap will allow for a softer edge 27 to flex and seal upon the harder plastic access means 36.

FIG. 12 (shown as expanded out from FIG. 10) depicts an expanded view in cross section of a secondary seal point in the bait station of the present invention when the cap 2 is fully closed down upon the base portion 3. In a non-limiting and preferred embodiment, cap 2 may be configured with a peripheral overhang having an underside face 25 that may seal down upon the outer rim 320 of the base. portion 3, when the bait station is in the fully closed position. As mentioned, this is a secondary sealing point that protects against leakage from the overall device should liquid bait leak out of the reservoir past the primary seal point and wick up around the wall of the cap to the fastening means 22-33. It is important to note this is simply one embodiment of a secondary sealing point. Base portion 3 may also be configured with a recessed “seat” at 320 to accommodate 25. In yet another example, seat 320 may include a recessed “O-ring” that may be deformed and sealed upon by overhanging surface 25 of cap 2. The underside 25 of the cap overhang may also include a sealing bead that fits into a slot carved into the rim 320 of the base portion (much like one embodiment of the primary seal shown in FIG. 11b). Again, it may be useful to mismatch the hardness of the plastic between the cap 2 and the base portion 3 such that one part may deform against the other to make a tighter seal.

FIG. 13 (shown as expanded out from FIG. 10) depicts an expanded view in cross section of a third seal point in the bait station of the present invention when the cap 2 is fully closed down upon the base portion 3. As mentioned above, a distinguishing feature of the bait station of the present invention is that the cap 2 also seals off the insect access port(s) when the device is completely closed. We discussed above that the cap might extend over the outside of the ports 34 or alternatively seal them from behind, depending in part on if the bait station incorporates an optional rain/weather shroud on the base portion. FIG. 13 shows a preferred embodiment where the cap wall 22 rides along the inside of the outer wall 32 of the base portion 3, and this is the preferred configuration when an optional rain/weather shroud is incorporated as an integral part of the base portion. As shown in FIG. 13, the bottom edge 24 of the wall 22 of cap 2 preferably tracks behind the insect access port 34 and crushes down onto a lower portion of the sloped access means 36. Again, it may be useful to mismatch the hardness of the plastic between the cap 2 and the base portion 3 such that one part may deform against the other and make a tighter seal. For example, a softer edge 24 of the cap wall 22 may deform against the harder plastic used in the base portion (and particularly at the point of contact at the lower portion of the sloped access means 36). As illustrated in this embodiment, edge 24 may be thinner than wall 22, being tapered, or as in this example notched, so that it forms a more predictable seal upon a sloped surface 36. When the station is opened through the movement of cap 2 relative to base portion 3, with concomitant displacement of the cap away from the base portion 3, the edge 24 will rise up behind the insect access port 34, opening the port up to the outside environment very much like a window shade being raised in a window. The friction fit between the bottom edge 24 of cap wall 22 and the sloped access means 36 forms another back-up seal to the primary liquid-tight seal on the top of the reservoir as depicted in FIGS. 11a-c. That is to say, if liquid bait leaks beyond the primary seal at the reservoir, it may splash down the sloped access means 36 where it will meet another seal—namely the seal between the lower edge 24 of the cap wall 22 and the sloped access means 36.

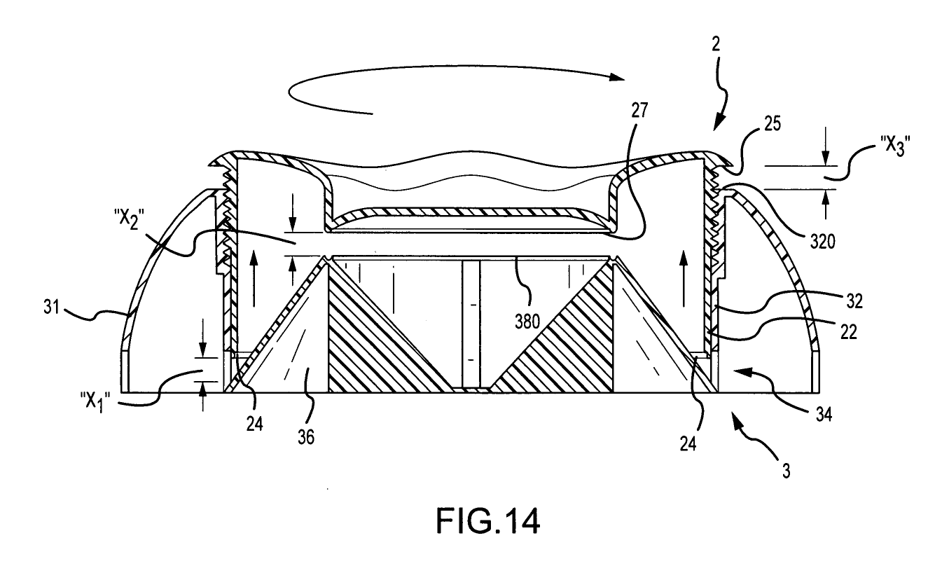

FIG. 14 depicts one embodiment of a partially opened station in cross-sectional view. As elaborated above, one essence of the invention is the control that the operator has to size the insect access ports and the crawlspaces within the bait station, and to have these openings and crawlspaces dimensioned equally and simultaneously through a single simple motion of the cap relative to the base portion. As indicated in FIG. 14, rotation in the preferred threaded arrangement of the cap relative to the base portion distances cap 2 from base portion 3 by distance “x”. FIG. 14 shows three such distances “x” that are necessarily all the same since a single contiguous part 2 is displaced a distance “x” from a second single contiguous part 3. Dimension “x₁” represents the opening created in the insect access port 34 when the cap is raised. Dimension “x₂” represents the crawlspace created between the sealing flange on the underside of the cap and the top of the reservoir wall. Lastly, “x₃”, (which is not an insect crawlspace or access for insects), is the distance to which the cap overhang is separated from the rim of the base portion when the cap is raised. The essence of the present invention is that the opening of the device may be in increments as determined by the size of the insects to be controlled. The device may be opened to a maximum where the entire size of the insect access ports is utilized. Incremental opening less than this maximum allows adjustment for the size of the insects. As mentioned in the introduction, the device may have markings that direct the operator to open the device to a particular setting for a chosen insect requiring control (“ANT”, “SMALL ROACH”, “LARGE ROACH”, etc.). As the operator opens the cap relative to the base portion, critical dimensions “x₁” and “x₂” parallel one another, that is, both the insect access ports and the crawlspace to the reservoir are dimensioned identically. The initial displacement of the cap breaks open the seal points at the insect access ports, around the periphery of the cap and at the top of the reservoir, and further movement of the cap opens up the insect access ports and crawlspaces to the desired dimension “x” for use of the bait station. As shown in this cross-sectional view, lower edge 24 of the cap 2 is distanced away from sloped access means 36. Simultaneously and to the same degree, sealing edge 27 on the underside of the cap 2 is distanced from the upper edge 380 of the inner reservoir. Although not an insect access route, the underside face 25 of the overhang of the cap 2 is also simultaneously distanced from the upper rim 320 of the base portion 3. As the operator moves and displaces the cap, cap 2 is distanced from the base portion 3 as shown in FIG. 14. As mentioned thoroughly above, the cap 2 may be moveably fastened to the base portion 3 by a variety of fastening means, including a simple friction fit of two smoothly molded parts. Thus, the distancing of the cap 2 relative to the base portion 3 may be through a “turning” motion or a simple “pulling” motion. Also mentioned above, the preferred shape for the insect access ports is square or rectangular, with the preferred size being from about 1-10 mm in height/width. Thus, the dimensions “x” when the device is opened are preferably between about 1-10 mm. Ideally, when the device is opened and put into operation for the control of an insect population, the dimension “x” (where necessarily “x₁”=“x₂”=“x₃”) is between about 1 and 10 mm.

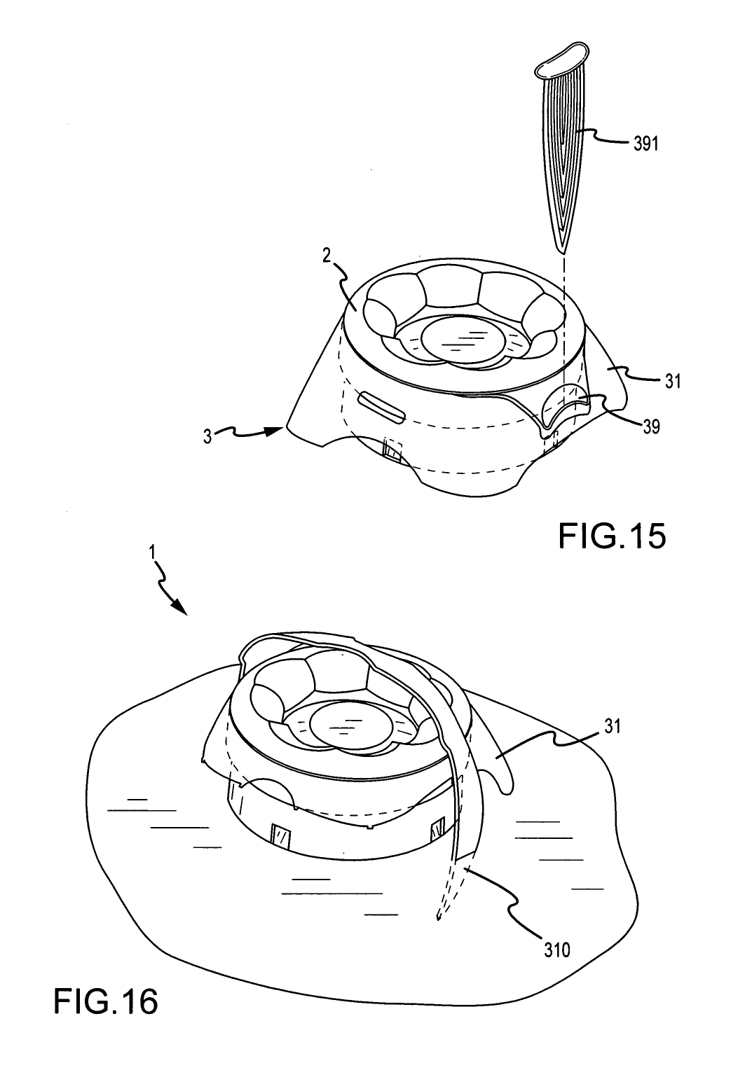

FIG. 15 depicts an upper perspective view of one embodiment of the bait station of the present invention comprising an optional spike 391 that may be used to secure the station. As mentioned above, this separate spike 391 may be included in a package that contains the bait station of the present invention. The consumer then merely removes both the spike 391 and the station 1 from the packaging and uses the optional spike to secure the station at the location for use. For example, the spike 391 may be pushed through a hole 39 appropriately sized and configured on the rain/weather shroud 31. Certainly the stake may be of configured in any number of forms, shapes and sizes having a variety of functional features, and may in fact be a screw or a nail that may be used to fix the station to a hard surface rather than a spike designed to push into the ground.

FIG. 16 depicts an upper perspective view of one embodiment of the bait station of the present invention in use comprising an integral spike 310 that was broken off from the rain/weather shroud 31. The spike 310 is shown being used to secure the bait station to the ground. The optional rain/weather shroud 31 may be perforated or molded with thin/fragile portions of plastic to aid the user in breaking off pre-marked portions such as the portion 310 depicted in FIG. 16. Appropriately shaped portions may be broken off by the user and used as a spike to secure the station to the ground as shown.

We claim:

1. A crawling insect bait station comprising a base portion and a cap movably fastened to one another;
a. said base portion including: (i) an outer wall with at least one insect access port and fastening means for securing a movable cap, (ii) an internal bait reservoir defined by a reservoir wall offset horizontally in from said outer wall; (iii) access means on exterior of said reservoir wall and optional access means on interior of said reservoir wall for facilitating climb and descent of said reservoir wall; and,
b. said movable cap including: (i) an outer wall with fastening means for moveable attachment to said base portion; and (ii) a downwardly projecting inner sealing flange offset horizontally from said cap outer wall, dimensioned and aligned to sealingly mate with said reservoir wall when the movable cap is fully closed onto the base portion.

2. The bait station of claim 1 further comprising a rain/weather shroud attached to said base portion.

3. The bait station of claim 1 further comprising a rain/weather shroud attached to said cap.

4. The bait station of claim 1 wherein said cap further includes a recessed or a protruding gripping means.

5. The bait station of claim 1 wherein said inner reservoir wall is substantially vertical and circular defining a substantially cylindrically shaped reservoir.

6. The bait station of claim 5 wherein said substantially cylindrical bait reservoir is from about 3 mL to about 30 mL in volume.

7. The bait station of claim 1 wherein said optional access means on said interior of said reservoir wall comprises at least one sloped ramp with an angle of from about 30° to about 60° from horizontal.

8. The bait station of claim 7 wherein said access means on said interior of said reservoir wall comprises from about 2 to about 8 sloped wedge-shaped ramps, each with angle of from about 30° to about 60° from horizontal, and each having a width of from about 1 mm to about 5 mm.

9. The bait station of claim 1 wherein said access means on exterior of said reservoir wall comprises a continuous sloped skirt surrounding said reservoir and angled down from the top of said reservoir wall to the outer wall of said base portion such that no horizontal floor exists between said outer wall of said base portion and said reservoir wall.

10. The bait station of claim 5 wherein said access means on exterior of said reservoir wall comprises a circumferential sloped skirt traversing the distance between the reservoir wall and the outer wall of the base portion.

11. The bait station of claim 10 wherein said circumferential skirt is sloped from the top of said reservoir wall down to the outer wall of the base portion at an angle of from about 30° to about 60° from horizontal.

12. The bait station of claim 5 wherein said access means on said interior of said reservoir wall comprises from about 2 to about 8 wedge-shaped sloped ramps with angle of from about 30° to about 60° from horizontal and width of from about 1 mm to about 5 mm.

13. The bait station of claim 12 wherein said access means on exterior of said reservoir wall comprises a circumferential skirt traversing the space between the said reservoir wall and said outer wall of the base portion, sloped from the top of said reservoir wall down to the outer wall of the base portion at an angle of from about 30° to about 60° from horizontal.

14. The bait station of claim 1 wherein said cap and said base portion are separate injection molded or injection blow-molded plastic components made from a plastic selected from the group consisting of polyethylene, polypropylene, polyethylene terephthalate, polyvinyl chloride, polystyrene, nylon, polycarbonate, and mixtures thereof.

15. The bait station of claim 1 wherein said fastening means on said cap and said fastening means on said base portion comprise complementary screw threads.

16. The bait station of claim 15 wherein said complementary threads are of coarseness of from about 1 TPI to about 16 TPI.

17. The bait station of claim 16 wherein said complementary threads are of coarseness from about 1 TPI to about 8 TPI, and further comprise a thread profile form selected from the group consisting of ISO Metric, SAE Unified, BA, and BSW standards.

18. The bait station of claim 1 wherein said cap and said base portion are in a pull-to-open arrangement such that pulling/pushing on said cap relative to said base portion distances one component relative to the other.

19. The bait station of claim 18 wherein said fastening means on said cap and said fastening means on said base portion comprise smooth tight-fitting surfaces such that the moveable fastening between said cap and said base portion is a friction fit.

20. The bait station of claim 18 wherein said fastening means on said cap is comprised of at least one protrusion and said fastening means on said base portion is comprised of at least one slot of complementary size and juxtaposition such that said protrusion on said cap registers and slides within said slot in said base portion when said cap is moved relative to said base portion.

21. The bait station of claim 18 wherein said fastening means on said base portion is comprised of at least one protrusion and said fastening means on said cap is comprised of at least one slot of complementary size and juxtaposition such that said protrusion on said base portion registers and slides within said slot in said cap when said cap is moved relative to said base portion.

22. The bait station of claim 1 wherein said at least one insect access port is substantially square in shape and measures from about 1 mm to about 10 mm square.

23. The bait station of claim 1 wherein said at least one insect access port is substantially rectangular in shape and measures from about 1 mm to about 10 mm in height and from about 1 mm to about 10 mm in width.

24. The bait station of claim 2 wherein said rain/weather shroud is perforated, scored, or otherwise molded such that portions of said shroud may be readily broken off along predetermined lines.

25. The bait station of claim 24 wherein said readily broken off portions of said shroud are shaped to function as a staking means to secure said bait station to the ground.

26. The bait station of claim 2 wherein said rain/weather shroud further includes a hole through which a separate spiking means may be deployed to secure said bait station to the ground.

27. A crawling insect bait station comprising a base portion and a cap movably fastened to one another;
a. said base portion including: (i) an outer wall with between 2 and 8 insect access ports and threaded fastening means for securing a movable cap, (ii) a substantially cylindrically shaped bait reservoir defined by a circular reservoir wall offset horizontally from said outer wall, (iii) sloped access means configured on the inside of said reservoir wall comprising between 2 and 8 angled ramps; (iv) sloped access means configured on the exterior of said reservoir wall comprising a single contiguous circumferential skirt traversing the distance between said reservoir wall and said outer wall of said base portion, both access means positioned for facilitating climb and descent of said reservoir wall; and,
b. said movable cap including: (i) an outer wall with threaded fastening means for moveable attachment to said threaded base portion; and (ii) a downwardly projecting inner sealing flange offset horizontally from said cap outer wall and positioned on the underside of said cap, dimensioned and aligned to sealingly mate with said reservoir wall when the movable cap is fully closed onto the base portion.

28. The bait station of claim 27 wherein said insect access ports are substantially square, each measuring from about 1 mm to about 10 mm square.

29. The bait station of claim 27 wherein said angled ramps and said circumferential skirt are each angled at from about 30° to about 60° from horizontal.

30. The bait station of claim 27 wherein said outer wall of said cap fits inside said outer wall of said base portion, such that said outer wall of cap rides along the inside of said outer wall of said base portion when said cap is movably fastened to said base portion and one component is moved relative to the other.

31. The bait station of claim 30 wherein said outer wall of said moveable cap seals behind each of said insect access ports when said cap is screwed down onto said base portion.

32. The bait station of claim 27 wherein said downwardly projecting inner sealing flange on underside of said cap further comprises a circular sealing edge concentric with a lip, said edge and lip dimensioned to seal just outside said reservoir wall when said cap is screwed down tightly onto said base portion, making a liquid tight seal at said reservoir.

33. The bait station of claim 27 wherein said downwardly projecting inner sealing flange on underside of said cap further comprises a circular sealing edge and concentric lip, each dimensioned such that said sealing edge fits just inside said reservoir wall and said concentric sealing lip seals on top of said reservoir wall when said cap is screwed down tightly onto said base portion, making a liquid tight seal at said reservoir.

34. The bait station of claim 27 further including a circular slot in the top of said reservoir wall.

35. The bait station of claim 34 wherein said downwardly projecting inner sealing flange on underside of said cap further comprises a circular sealing edge and concentric lip, each dimensioned such that said sealing edge substantially fits within said circular slot in the top edge of said reservoir wall and said concentric lip seals on top of said reservoir wall when said cap is screwed down tightly onto said base portion, making a liquid tight seal at said reservoir.

36. A crawling insect bait station comprising a base portion and a cap movably fastened to one another;
a. said base portion including: (i) an outer wall with between 2 and 8 substantially square insect access ports measuring between 1 mm and 10 mm square and a threaded fastening means for securing a movable cap; (ii) a substantially cylindrically shaped bait reservoir defined by a circular reservoir wall offset horizontally from said outer wall, said bait reservoir between about 3 mL and 30 mL in volume; (iii) sloped access means comprising between 2 and 8 angled ramps of about 50° in slope configured on the interior of said reservoir; and (iv) sloped access means comprising a single contiguous circumferential skirt configured on exterior of said reservoir, traversing the distance between said reservoir wall and said outer wall of said base portion on an angle of about 50°, wherein both access means are positioned on each side of said reservoir wall for facilitating climb and descent of said reservoir wall by insects; and,
b. said movable cap including: (i) an outer wall with threaded fastening means for moveable attachment to said threaded base portion; and (ii) a downwardly projecting inner sealing flange offset horizontally from said cap outer wall and positioned on the underside of said cap, said sealing flange further comprising concentric sealing edge and substantially horizontal lip, each dimensioned and aligned to sealingly mate with said reservoir wall when the movable cap is fully closed onto the base portion.

37. The bait station in claim 36 wherein said cap and said base portion are separate injection molded or injection blow-molded plastic components made from a plastic selected from the group consisting of polyethylene, polypropylene, polyethylene terephthalate, polyvinyl chloride, polystyrene, nylon, polycarbonate, and mixtures thereof.

38. The bait station in claim 36 further including a rain/weather shroud integrally molded as part of said base portion.

39. The bait station of claim 38 wherein said rain/weather shroud is perforated, scored, or otherwise molded such that portions of said shroud may be readily broken off along predetermined lines.

40. The bait station of claim 39 wherein said at least one readily broken off portion of said rain/weather shroud is shaped to function as a securing means to secure said bait station to the ground.
